(19) United States
(12) Patent Application Publication
(10) Pub. No.: US 2010/0095924 A1
(43) Pub. Date: Apr. 22, 2010

(54) DEVICE AND METHOD FOR FILTERING ENVIRONMENTAL AIR THROUGH USE OF A VEHICLE

(76) Inventor: Clark Harper, Sandy, UT (US)

Correspondence Address: TRASKBRITT, P.C., P.O. BOX 2550, SALT LAKE CITY, UT, 84110, US

(21) Appl. No.: 12/580,402

(22) Filed: Oct. 16, 2009

Related U.S. Application Data
(60) Provisional application No. 61/196,324, filed on Oct. 16, 2008.

(51) Int. Cl. F02M 35/02

(52) U.S. Cl. 123/198 E

(57) ABSTRACT

An air filtering device and method for a vehicle includes an air intake port for securement on a vehicle such that a motion of the vehicle urges environmental air through an intake port; a filter in fluid communication with the air intake port; and an outlet port in fluid communication with the air filter. The device and method are configured to receive an air flow created by a motion of the vehicle, filter that air flow and remove gaseous and/or particulates from that air flow and thereafter return the filtered air to the environment.

### CROSS REFERENCE TO RELATED APPLICATIONS

This application claims the benefit under 35 U.S.C. §119 (e) to United States Provisional Application No. 61/196,324, which application is incorporated herein by reference.

### FIELD OF THE INVENTION

The present invention relates to devices and methods for filtering environmental air, in particular, the invention is directed to a device and method for filtering environmental air using a vehicle.

### DESCRIPTION OF THE RELATED ART

One of the main causes and contributors to global warming is the release of emissions from cars, trucks, buses, construction vehicles and other automobiles that are powered by fossil fuels. As the population increases so does the number of motor vehicle operators. Increased vehicular traffic results in the further contamination of the environment, especially the atmosphere. While automobile companies are making more fuel-efficient and eco-friendly vehicles, the number of vehicles being produced yearly has increased thereby offsetting any progress made by vehicle manufacturers.

Global warming and the ozone levels in the Earth's atmosphere are a significant international concern. Per the U.S. Environmental Protection agency (EPA) “Hydrocarbons and nitrogen oxides come from a great variety of industrial and combustion processes.” In typical urban areas at least half of the pollutants found in those areas originate from cars, buses, trucks, and off-highway mobile sources such as construction vehicles and boats.”

One of the largest contributors to global warming and increasing Ozone Levels are the carbon emissions emitted from gas and fossil fuel powered vehicles. As the world population increases so does the number of vehicles that are driven in the world. The more vehicle miles that are driven, the more the air is contaminated.

Although vehicles are getting cleaner as far as their emissions are concerned, the number of vehicles on the road keeps increasing every year. As a result more miles are driven each year offsetting progress in ozone pollution control.

Notwithstanding the improvements in automobile emission systems, there contains to be a need to devices and methods to remove pollutants from the environment, especially the atmosphere.

### BRIEF SUMMARY OF THE INVENTION

An air filtering device and method which may be utilized in association with a vehicle is disclosed. The device includes an air intake port, an air filter in fluid communication with the air intake port, and an air outlet port in fluid communication with the air filter. The air intake port configured for securement to a vehicle such that a motion of the vehicle operates to urge environmental air through the air intake port. The air filter, being in fluid communication with the air intake port, is adapted to receive a flow of air from the air intake port and thereafter remove environmental pollutants from that flow of air. These pollutants may include gaseous pollutants, such as hydrocarbons, sulfates, as well as particulates. The air outlet port, being in fluid communication with the air filter, is configured to received a quantity of filtered environmental air from the filter. The air outlet port is configured to return the filtered air to the environment. In a preferred construction, the air outlet port returns the filtered air directly to the environment. In one embodiment, the air filter fluidly communicates directly with the environment around the vehicle's exterior through the outlet port.

In an additional embodiment, a method for filtering environmental air using the motion of a vehicle. The method includes providing an air intake port coupled to a vehicle such that motion of the vehicle urges environmental air through the air intake port; interconnecting the air intake port to a filter constructed to filter environmental pollutants, e.g. gaseous and or particulate pollutants, from the environmental air; and interconnecting the air filter to an air outlet port which communicates with the environment. In a preferred embodiment, the air outlet port is oriented and arranged to discharge air, filtered through the air filter, directly into the environment, e.g. the environment about the vehicle's exterior.

It is contemplated that the invention may comprise, consist essentially of, or consist of any and all of the elements or features described herein.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 is a perspective view of an air filtering device and method, according to one embodiment of the invention;

FIGS. 2 and 3 are a side cross-sectional view of an air filtering device and method, according to one embodiment of the invention;

FIG. 4 is a perspective view of an air filtering device and method adapted for use in a vehicle, according to one embodiment of the invention.

FIG. 5 illustrates an air filtering device and method adapted for use in a vehicle, according to one embodiment of the invention;

FIG. 6 illustrates an air filtering device and method adapted for use on the front portion of a vehicle, according to one embodiment of the invention;

FIG. 7 illustrates an air filtering device and method adapted for use on the rear portion of a vehicle, according to one embodiment of the invention; and

FIG. 8 illustrates an air filtering device and method adapted for use on the large commercial vehicle, according to one embodiment of the invention

### DETAILED DESCRIPTION OF THE INVENTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination, and may comprise, consist essentially of, or consist of the various elements and features described herein.

Reference will now be made to the drawings. Like elements are identified by like numerals. The drawings are not necessarily to scale.

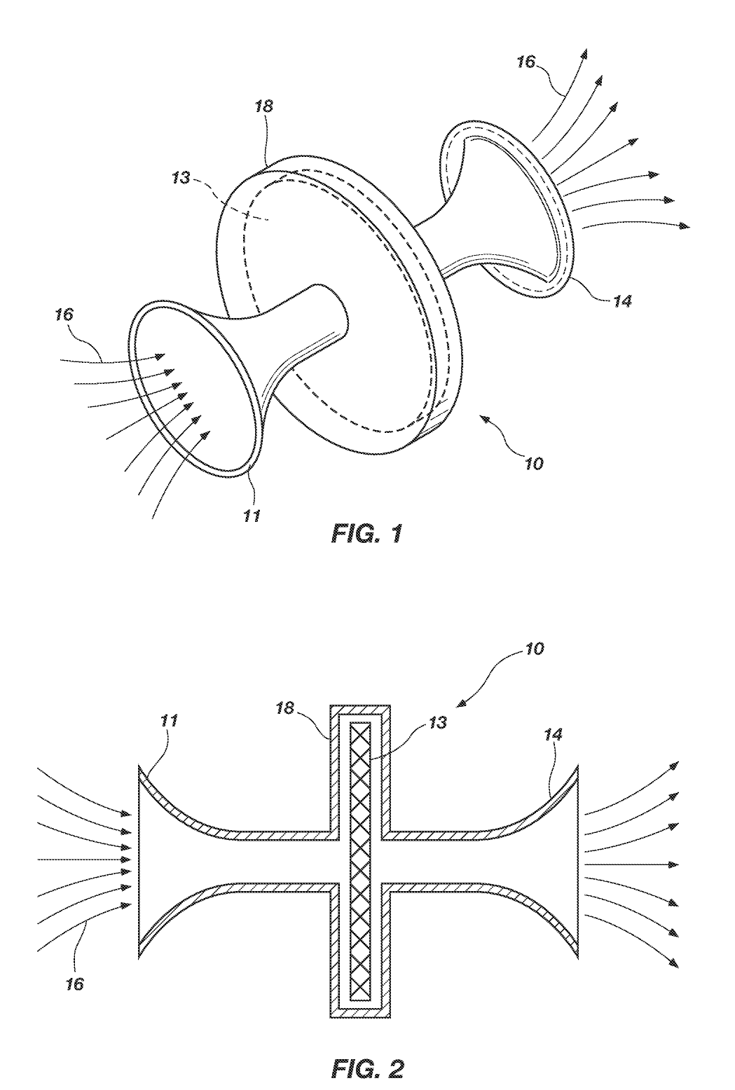

FIG. 1 is perspective view of an air filtering device 10, according to one embodiment of the invention. Shown is an air filtering device 10 which includes an air intake port 11 secured, or otherwise couplable on a vehicle 12 such that a motion of the vehicle 12 urges environmental air 16 through the air intake port 11. It is contemplated that the air intake port 11 may be oriented and positioned on various parts of the vehicle. In preferred constructions, the inlet of the air intake port is oriented into the direction of air flow over the surface of the vehicle 12 when the vehicle is displaced in a forward direction. In one non-limiting example, the intake port 11 may be interconnected with, or otherwise be part of the grill of a vehicle 12.

Shown in FIG. 1, the device 10 further includes an air filter 13 in fluid communication with, or otherwise fluidly connected to the air intake port 11. It is contemplated that the air filter 13 may be one of many types or kinds of air filters that are configured to remove contaminants or unwanted elements from the airflow passing into the air intake port 11.

In one embodiment, shown in the Figures, the air filter 13 is positioned on the frontal portion of the vehicle 12. In that regard, the air filter 13 is positioned substantially contiguous with the air intake port 13 whereby air received within the air intake port is communicated directly to the air filter 13, thereby facilitating a maximum airflow to the filter from the air intake port.

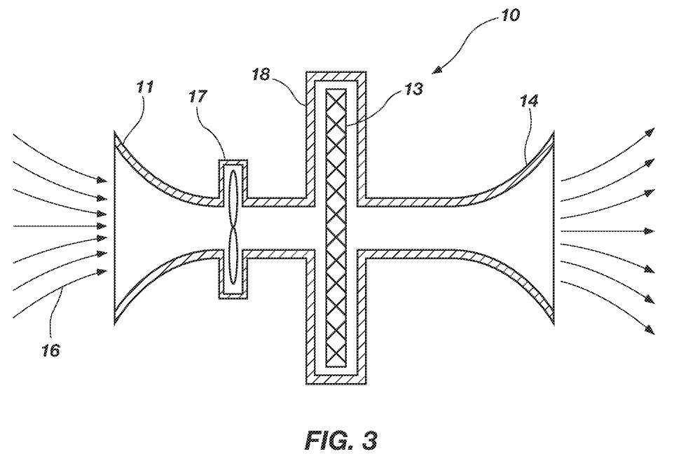

In an alternative embodiment, shown in FIGS. 1 and 2, the air filter 13 may be at least partially encased by a housing 18. The housing 18 operates to direct air received from the air intake port 11 through the air filter while minimizing the likelihood that any air received from the air intake port will be exhausted through the air outlet port 14 without first having passed through the air filter. In preferred constructions, the interior of the housing 18 is constructed to closely conform to the exterior surface of the air filter thereby forming a passageway from the air intake port which defines a minimum opportunity for the passage of air about the exterior of the filter and thereafter to the air outlet port 14. The housing 18 may be composed of type of a variety of materials, such as but not limited to metal, plastic, etc.

Shown in FIG. 3, the housing and the air intake port may be fluidly connected to a fan element 17, such that the fan element 17 may assist in forcing air through the air intake port.

In another embodiment, the air filter 13 is configured to remove, or otherwise filter greenhouse gas elements from air passing therethrough. Such air filters may be available from Air Filters, Inc. of Warren, Tex., a provider marketing its products through the world wide web at www.airfilterusa.com and from Carbtol® of Bridgeport, Conn., a provider marketing its products on the world wide web at www.carbtrol.com. Greenhouse gas elements are defined as those elements found in greenhouse gases, such as, but not limited to, carbon dioxide, methane, nitrous oxide, ozone, chlorofluorocarbons (CFC), and so forth.

In one embodiment, it is contemplated that the device and method, may be combined with multiple devices on multiple vehicles, e.g., on large numbers of vehicles, and that such a coordination of filtering devices can significantly improve air quality and lessen the amounts of carbon emissions and potentially reduce global warming caused by the emission of fossil fueled vehicles. Indeed, the device and method on potentially millions of vehicles can have a significant impact on the environment and decreases and replace contaminated emissions from vehicles.

Also shown in FIG. 1, the device 10 further comprises an outlet port 14 in fluid communication with the air filter 13 and configured to allow air passing through the air filter 13 to be returned to the environment, without further contamination from the vehicle. It is contemplated that, in one embodiment, the air filter 13 fluidly communicates directly with the environment about or around vehicle's exterior through the outlet port 14. The outlet port 14 may be embodied in any size, shape, or design, such as, but not limited to, a discharge vent or opening. In one non-limiting example, the outlet port 14 includes one or more fins or fin shaped protrusions that extend outward from the vehicle 12.

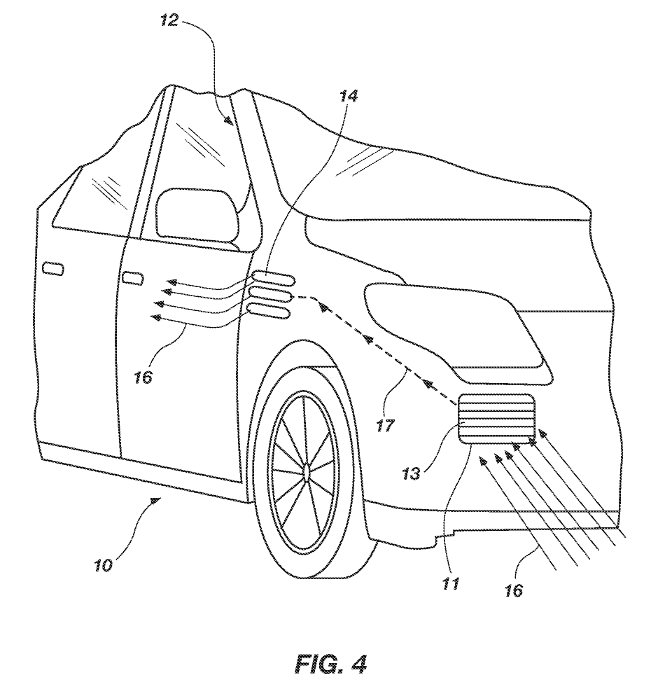

FIG. 4 is a partial frontal perspective of a vehicle 12 illustrating the air filtering device and method adaptable for use in a vehicle 12. The device 10 and instant method is configured, or otherwise secured to a vehicle 12 such that air 16 from the environment, exterior of the vehicle, induced by the motion of the vehicle, or otherwise flowing over the surface of the vehicle, flows into the air intake port 11, passes through the air filter 13, and then travels (as indicated by directional arrow 17) to an outlet port 14. It is contemplated that the air 16 may travel, as shown by directional arrow 17, through the interior of the construction formed by the air intake port, air filter and air outlet port toward the outlet port 14 through conventional piping or airflow tubing that can be adapted for use in a vehicle 12. As shown, the air intake port 11 is positioned on the front portion of the vehicle 12 such that maximum airflow through the air intake port is potentially achieved.

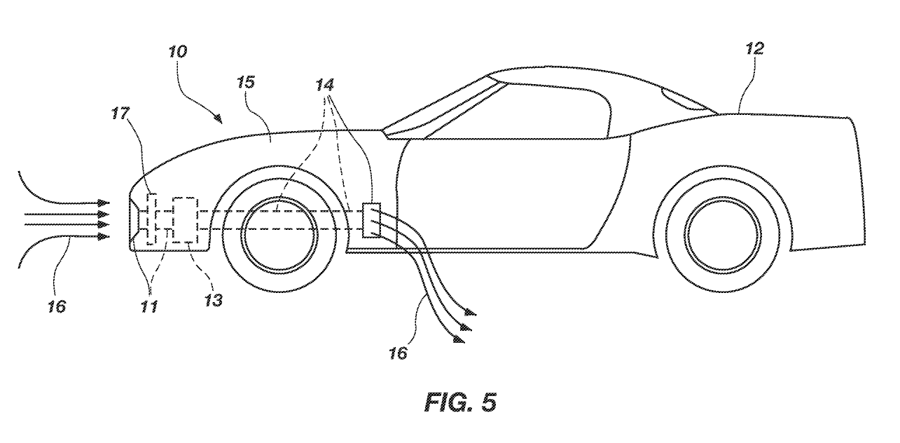

Illustrated in FIG. 5 is a side view of a vehicle 12 showing an embodiment wherein the device 10 and method are at least partially adapted for placement within an interior region of a vehicle 12. A shown, the air 16 from the outside enters and travels through the air intake port 11, passes through the air filter 13, and then exists through air outlet port 14.

In the various embodiments of the invention, one or more of the various components of the invention, i.e. the air intake port, the air filter and the air outlet port, may be structured for interconnection to one or more structural elements of the vehicle to form a means of securing the invention to the vehicle. In this regard, one or more of the components of the invention may be fitted with mounting structure, e.g. mounting brackets, adapted to secure the invention to the vehicle.

Shown in FIG. 5, the device 10 and method may comprise a fan element 17, configured to urge an additional quantity of air 16 through the air filtering device 10, in excess of that which would otherwise be urged through the air filter by the motion of the vehicle. As shown, the fan element 17 is in fluid communication with the air intake port 11 and the air filter 13. It is additionally contemplated that the fan element may include one or more sensors configured to start or stop the fan element in response to environmental conditions, such as a reduction in airflow or reduction in speed of the vehicle.

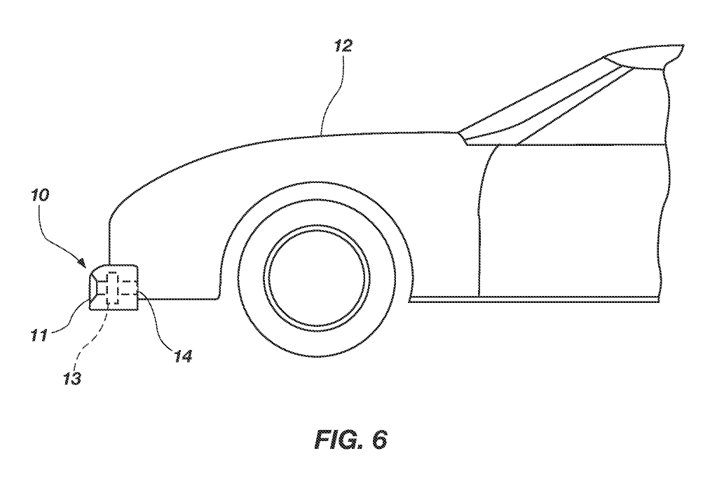

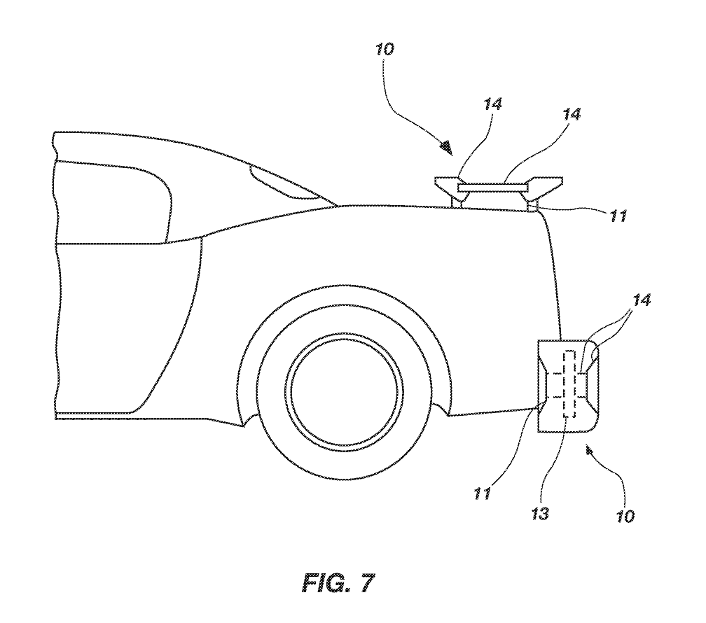

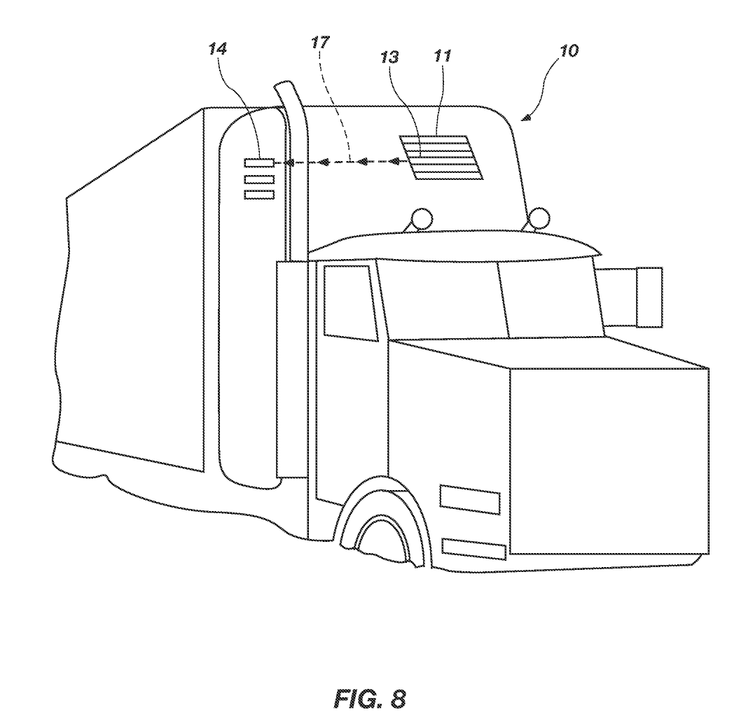

As shown in FIGS. 6, 7, and 8, it is contemplated that the device 10 and method may be coupled to, or otherwise be applicable to or adapted for, attachment to the exterior of a vehicle 12. In some non-limiting examples, as shown, the device 10 may be incorporated into the bumper of a vehicle or incorporated into the spoiler of a vehicle 12. Also shown the air intake port 11 and the outlet port 14 may be oriented in an opening defined within the vehicle 12 that exposes the air filter 13 to direct fluid communication with the environment through the air intake port. Also shown, the device 10 and method may be adapted for use in commercial vehicles.

As shown in FIGS. 1 through 6, the air filter 13 fluidly communicates directly with the environment about or around the vehicle's exterior through the outlet port 14. The air filter 13, being in direct fluid communication with the exterior of the vehicle 12, provides several advantages and is distinguished from conventional vehicle air filtering systems and devices. In a conventional vehicle, a flow of air is introduced into the engine of the vehicle after initially being directed through an air filter adapted to remove particulates from the air. The filtered air is then introduced into the cylinders of an internal combustion engine where it is combusted together with a hydrocarbon fuel mixture. The air is then exhausted from the cylinders through a conventional exhaust emission system. The air flows through a muffler and is subsequently exhausted to the environment, ladened with the exhaust byproducts of the combustion process.

In one embodiment of the invention, it is contemplated that the air filtering device 10 may include solely an air intake port adapted for securement on a vehicle such that a motion of the vehicle urges environmental air through the intake port; a filter in fluid communication with the air intake port; and an outlet port in fluid communication with the air filter configured to direct filtered air exiting the air filter directly back into the environment.

In one aspect of the invention, the air filter device and method transforms conventional vehicles into moving air filtering devices, as they perform typical travel duties. The invention takes in polluted environmental air through an air intake port. In one aspect of the invention, it contemplated that the air intake port is a separate from, or otherwise not part of a conventional vehicle engine air intake system.

Typically, the motion of a vehicle urges air to pass through the air filter device and thereby filter pollutants from the air and thereafter direct the filtered air back into the environment through the air outlet port 14. The clean air passing through the air filter device and method, which in one embodiment, is separate from an engine's vehicle exhaust system, may, in some instances, offset the emissions the vehicle emits to the environment through the vehicle's exhaust system.

The operation of a vehicle fitted with an air filter device or system of the instant invention may result in the cleaning and disbursement of more fresh air than the vehicle is currently producing, offsetting the harmful emissions the vehicle is giving off from the exhaust, effectively helping to create “carbon neutrality,” e.g., a larger volume of filtered air can offset the harmful emissions released through a vehicles normal exhaust system.

It is contemplated that the air filter device and method can be developed in various sizes and capacities and may be able to reduce harmful emissions by a minimum of 50% or more in vehicles to which it is secured.

In a situation in slow or heavy traffic, like city driving or slow freeway commutes, the fan element in the air filter device and method may assist to urge air through the device in sufficient volume to off-set the vehicles emissions at slower travel speeds.

In one embodiment, the air filter device and method is an eco-friendly application for all vehicles and construction equipment that would take in outside air and filter it, compensating for the level of harmful emissions released from the vehicle's exhaust. The filter device of the invention may be hidden within the vehicle for a more discreet look.

In an exemplary operational embodiment, the air filter device and method receives polluted air as the vehicle is in motion, utilizing the vehicle's speed to urge the air to travel in the desired direction through the structure of the device. The air travels through the air filtering device 10 and clean air is released back into the environment through ejection vents or the outlet port 14. Those vents may be located on the side panel or fender or on the back of the spoiler for vehicles, depending on the type of vehicle. When the air is released through the ejection vent, the air is thoroughly scrubbed, offsetting the damaging emissions that are typically passed through the vehicle's exhaust.

It is contemplated that the interior components and operations of the air filter device and method may vary depending on the type of vehicle (car, truck, forklift). It is additionally contemplated that the air filter device and method may be an after-market attachment for vehicles or can be installed on vehicles during their manufacture. Exact dimensions and embodiments of the air filter device and method may vary and may be determined upon manufacture.

Although the foregoing description includes many specifics, these should not be construed as limiting the scope of the present invention but, merely, as providing illustrations of some of the presently preferred embodiments. Similarly, other embodiments of the invention may be devised which do not depart from the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed is:

1. An air filtering device for a vehicle, the air filtering device comprising:
an air intake port, adapted for coupling to a vehicle in an orientation, such that a motion of the vehicle urges environmental air through the air intake port;
an air filter in fluid communication with the air intake port; and
an outlet port in fluid communication with the air filter and configured to receive air from the air filter and direct said air directly into the environment surrounding said vehicle.

2. The air filtering device of claim 1, wherein the air filtering device is adapted for coupling to an exterior surface of said vehicle.

3. The air filtering device of claim 1, wherein the air filtering device is adapted for coupling to an interior surface of said vehicle.

4. The air filtering device of claim 1, further comprising a fan element positioned in fluid communication with the air intake port, configured to increase an airflow through the air intake port.

5. The air filtering device of claim 1, further comprising a housing at least partially encasing the air filter.

6. The air filtering device of claim 1, wherein the air filter is configured to remove greenhouse gases from air passing therethrough.

7. The air filtering device of claim 1, wherein the air intake port is interconnected with the grill of a vehicle.

8. An air filtering device for a vehicle consisting essentially of:
an air intake port configured for securement on a vehicle such that a motion of the vehicle urges environmental air through the intake port;
a filter in fluid communication with the air intake port; and
an outlet port, in fluid communication with the filter, configured to direct air, exiting the air filter, directly to the environment.

9. A method for filtering environmental air using a motion of a vehicle, the method comprising:
providing an air intake port;
coupling said air intake port to a vehicle such that a motion of the vehicle urges environmental air through the intake port;
positioning an air filter in fluid communication with said air intake port;
positioning an air outlet port in fluid communication with said air filter to direct a flow of filtered air from said air filter directly to the environment.

10. The method of claim 9, further comprising enclosing the filter in a housing.

11. The method of claim 9, further comprising securing the air intake port, the filter, and the outlet port on the exterior of a vehicle.

12. The method of claim 9, further comprising securing the air intake port, the filter, and the outlet port in the interior of a vehicle.
